(19) United States
(12) Patent Application Publication
(10) Pub. No.: US 2015/0318684 A1
(43) Pub. Date: Nov. 5, 2015

(54) Circuit Device and Electronic Apparatus

(71) Applicant: Osram GmbH, Munich (DE)

(72) Inventors: Xiaoming FU, Shenzhen (CN); Yong PENG, Shenzhen (CN); Haibin XIAO, Shenzhen (CN); Ju ZHANG, Shenzhen (CN)

(21) Appl. No.: 14/650,322

(22) PCT Filed: Dec. 3, 2013
(86) PCT No.: PCT/EP2013/075410

§ 371 Date: Jun. 8, 2015

(30) Foreign Application Priority Data
Dec. 7, 2012 (CN) 201220674829.6

(51) Int. Cl. H02H 7/12; H05B 33/08; H02M 3/04

(52) U.S. Cl. CPC H02H 7/1213; H02M 3/04; H05B 33/0887

(57) ABSTRACT

Various embodiments may relate to a circuit device and an electronic apparatus. The circuit device may include a main circuit unit, an energy store and output unit and a valley detection unit. The main circuit unit transfers energy to the energy store and output unit according to a detected voltage of the valley detection unit. Furthermore, the circuit device described above also includes a malfunction processing unit for preventing the main circuit unit from transferring energy to the energy store and output unit by adjusting the detected voltage of the valley detection unit in the case that the energy store and output unit has an output malfunction. Hereby, elements in the circuit device may be prevented from being damaged by the output malfunction. Moreover, the circuit device has a simple structure and is cost effective.

### RELATED APPLICATIONS

The present application is a national stage entry according to 35 U.S.C. §371 of PCT application No. PCT/EP2013/075410 filed on Dec. 3, 2013, which claims priority from Chinese application No.: 201220674829.6 filed on Dec. 7, 2012, and is incorporated herein by reference in its entirety.

### TECHNICAL FIELD

The present disclosure generally relates to the field of circuits and particularly to a circuit device and an electronic apparatus.

### BACKGROUND

In the course of using a circuit device, e.g., a power supply circuit, a driver circuit, etc., the circuit device may have an output malfunction, e.g., an abnormal operation of a load (such as an LED lamp emitting no light), etc., due to a failure internal to the circuit, a loosened connection, an improper operation of a user or other reasons, or the like.

In an existing circuit with a valley detection function, for example, an output of the circuit may have an output malfunction, for example, in the case of the output being disconnected from a load, an occurring open-circuit of the load, etc. However, the existing circuit can not solve the output malfunction as mentioned above by using the valley detection function.

### SUMMARY

In view of the foregoing drawback of the related art, various embodiments provide a circuit device so as to overcome at least the problem that an existing circuit device with a valley detection function can not solve an output malfunction.

In order to attain the foregoing object, various embodiments provide a circuit device including a main circuit unit, an energy store and output unit and a valley detection unit, wherein the main circuit unit transfers energy to the energy store and output unit according to a detected voltage of the valley detection unit. Furthermore the circuit device further includes a malfunction processing unit configured to prevent the main circuit unit from transferring energy to the energy store and output unit by adjusting the detected voltage of the valley detection unit in the case that the energy store and output unit has an output malfunction.

According to an embodiment, the malfunction processing unit described above may be configured to judge that the energy store and output unit has an output malfunction when an output voltage of the energy store and output unit rises abnormally, in the case that the main circuit unit stops transferring energy to the energy store and output unit.

According to an embodiment, the malfunction processing unit described above may be configured to prevent the main circuit unit from transferring energy to the energy store and output unit by sensing the abnormal rising of the output voltage of the energy store and output unit and making the detected voltage of the valley detection unit reflect abnormal rising of the output voltage when the malfunction processing unit judges that the energy store and output unit has an output malfunction.

According to an embodiment, the circuit device includes any one of the following topologies: a reverse buck topology, a low-side buck topology, a fly-back topology and a boost-buck topology.

According to an embodiment, the malfunction processing unit may include a zener diode, a first resistor and a second resistor. A series circuit of the first resistor and the zener diode may be connected in parallel with a power supply capacitor for supplying power to the main circuit unit, the cathode of the zener diode may be coupled with a high-potential end of the power supply capacitor, and the anode of the zener diode may be coupled through the second resistor with a coupling node at which the main circuit unit is coupled with the valley detection unit, wherein the main circuit unit receives the detected voltage of the valley detection unit at the coupling node.

Various embodiments further provide an electronic apparatus including the circuit device as described above, where the circuit device is used for driving a load of the electronic apparatus.

According to an embodiment, the electronic apparatus described above may be a constant-current output power supply.

According to an embodiment, the electronic apparatus described above may be an LED driver.

The circuit device and the electronic apparatus according to various embodiments as described above may achieve at least one of the following advantages. When the energy store and output unit has an output malfunction, the main circuit unit may be prevented from transferring energy to the energy store and output unit by adjusting the detected voltage of the valley detection unit to thereby solve the output malfunction described above; and an element of the circuit may be protected with a small number of elements at a low cost.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 is a circuit block diagram illustrating schematically an exemplary configuration of a circuit device according to an embodiment of the present disclosure;

FIG. 2 is a circuit diagram illustrating schematically an application example of the circuit device according to the embodiment of the present disclosure;

FIG. 3 illustrates schematically a circuit diagram in the related art corresponding to the circuit device illustrated in FIG. 2;

FIG. 4 is a diagram illustrating an output voltage waveform and a valley detected voltage waveform in an example in the case that an energy store and output unit is connected with a load; and

FIG. 5 is a diagram illustrating an output voltage waveform and a valley detected voltage waveform in an example in the case that an energy store and output unit is disconnected from a load.

### DETAILED DESCRIPTION

Exemplary embodiments of the present invention will be described hereinafter in conjunction with the accompanying drawings. In the interest of clarity and simplicity, not all features of an actual implementation are described herein. However, it will be appreciated that in the development of any actual embodiment, numerous implementation-specific decisions shall be made to achieve the developers' specific goals, such as compliance with system-related and business-related constraints, which may vary from one implementation to another. Moreover, it will be appreciated that such a development effort might be complex and time-consuming, but would nevertheless be a routine undertaking for those skilled in the art having the benefit of the present disclosure.

In addition, it is noted that only those device structures and/or processing steps that are closely related to the technical solution of the present invention are shown in the figures to avoid unnecessarily obscuring the present invention. Other details that are not closely related to the present invention are omitted.

An embodiment of the present disclosure provides a circuit device which can solving an output malfunction occurring in its output part with its own valley detection function.

The circuit device includes a main circuit unit, an energy store and output unit and a valley detection unit, and the main circuit unit transfers energy to the energy store and output unit according to a detected voltage of the valley detection unit. Furthermore the circuit device also includes a malfunction processing unit configured to prevent the main circuit unit from transferring energy to the energy store and output unit by adjusting the detected voltage of the valley detection unit in the case that the energy store and output unit has an output malfunction.

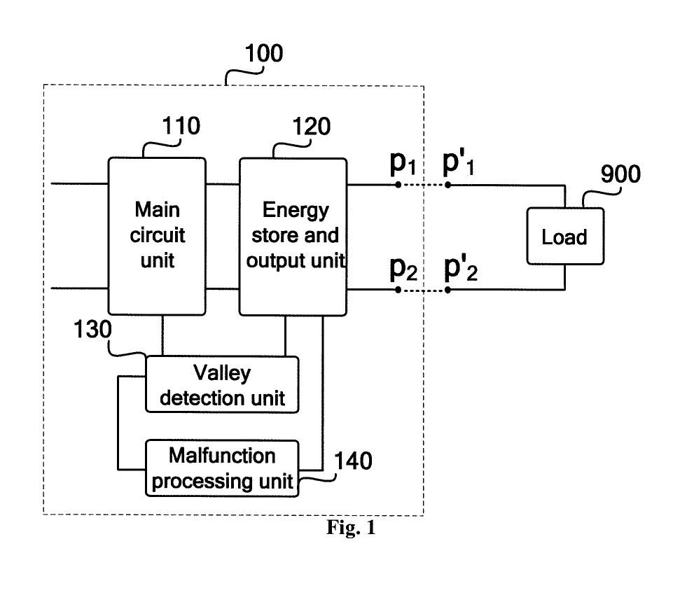

An exemplary configuration of the circuit device will be described below in details with reference to FIG. 1.

As illustrated in FIG. 1, the circuit device 100 according to the embodiment of the present disclosure includes a main circuit unit 110, an energy store and output unit 120 and a valley detection unit 130.

Like a traditional circuit with a valley detection function, the main circuit unit 110 has two operating statues, i.e., an ON status and an OFF status in the circuit device 100. Typically the main circuit unit 110 is switched cyclically between these two operating statuses.

In the ON status, the main circuit unit 110 transfers energy to the energy store and output unit 120. When the energy stored in the energy store and output unit 120 accumulates to some extent, the main circuit unit 110 is switched to the OFF status and has a broken coupling with the energy store and output unit 120, thus stops transferring energy to the energy store and output unit 120. Furthermore, in the ON status, if the energy store and output unit 120 is coupled with a load 900, the main circuit unit 110 can power the load 900.

Particularly the valley detection unit 130 is configured to perform a valley detection function of the circuit device 100. In the circuit device 100, the main circuit unit 110 can transfer energy to the energy store and output unit 120 according to the detected voltage of the valley detection unit 130.

In the case that the main circuit unit 110 is in the OFF status, if the voltage detected by the valley detection unit 130 is below or at a preset “valley”, then the main circuit unit 110 will be triggered by the detected voltage below or at the “valley” to be switched from the OFF status to the ON status; otherwise, the main circuit unit 110 will be maintained in the OFF status.

In the embodiment of the present disclosure, the valley detection unit 130 can be implemented in an existing valley detection technology. This can be known to those skilled in the art from general knowledge and/or public disclosures, so a repeated description thereof will be omitted here.

In normal operation, an output of the energy store and output unit 120 is coupled with a load 900, that is, P₁ is coupled with P′₁ and P₂ is coupled with P′₂, as illustrated in FIG. 1. Thus the energy store and output unit 120 can still power the load 900 in the case that the main circuit unit 110 stops transferring energy to the energy store and output unit 120 to make the load 900 operate normally. For example, the load 900 can be an LED assembly, a resistor or any other load. In the course of the energy store and output unit 120 powering the load 900, energy remaining on the energy store and output unit 120 will be decreased gradually with the progression of powering. Upon powering to some extent, the remaining energy will not be sufficient to bring the load 900 into operation, and at this time it is necessary to transfer energy to the energy store and output unit 120 again, that is, to switch the operating status of the main circuit unit 110 from the OFF status to the ON status. As above, when the energy remaining on the energy store and output unit 120 is not sufficient to bring the load 900 into operation, the valley detection unit 130 will detect a voltage below or at the predetermined “valley” so that the main circuit unit 110 can be switched from the OFF status to the ON status to transfer energy to the energy store and output unit 120 again.

However as described above, the energy store and output unit 120 may have an output malfunction while the circuit device 100 is in operation due to numerous circumstances in practical applications. In an example, the energy store and output unit 120 may have an output malfunction, e.g., an abnormal rising of an output voltage.

The abnormal rising of the output voltage may result from numerous reasons in practice, for example, a coupling between the output of the energy store and output unit 120 and the load being broken due to a loosened connection, an improper operation of a user or other reasons, or an occurring open-circuit internal to the load.

In respective embodiments to be described below, the description will be given taking a broken coupling between the output of the energy store and output unit 120 and the load as an example of the output malfunction. It shall be noted that the respective embodiments below will not only be applicable to the scenario where a coupling between the output of the energy store and output unit 120 and the load is broken but also can be applicable to other output malfunction scenarios where the abnormal rising of the output voltage of the energy store and output unit 120 results from an open-circuit of the load, an internal failure of the circuit device 100 or other reasons.

As illustrated in FIG. 1, in an example, when at least one of the couplings between P1 and P′₁ and between P₂ and P′₂ is broken, an output malfunction appears, thus resulting in an abnormal rising of the output voltage of the energy store and output unit 120. In this abnormal situation, the load 900 can not be powered by the energy store and output unit 120 any longer.

In some existing circuits with a valley detection function, the occurrence of the abnormal situation described above may result in a damage to an element internal to the circuits and even possibly endanger the personal life of the user upon occurrence of the abnormal situation described above. Furthermore, when the abnormal situation described above occurs in the existing circuits, after a period of time, a valley detection part (equivalent to the valley detection part 130 in the circuit device 100) will further trigger a main circuit part (equivalent to the main circuit unit 110 in the circuit device 100) to transfer energy to the output part again upon detection of a “valley”, and consequently the output part will cause an “over-voltage” above a rated voltage of an element therein, thus resulting in a destructive damage to the element of the circuit.

In view of the above, a malfunction processing unit 140 is further arranged in the circuit device 100 according to the embodiment of the present disclosure. As illustrated in FIG. 1, in the case that the main circuit unit 110 is in the OFF status, when the energy store and output unit 120 has an output malfunction, the malfunction processing unit 140 can prevent the main circuit unit 110 from transferring energy to the energy store and output unit 120 by adjusting the detected voltage of the valley detection unit 130 such that the output malfunction can be solved.

In an implementation of the circuit device according to the embodiment of the present disclosure, in the case that the main circuit unit 110 stops transferring energy to the energy store and output unit 120 and the energy store and output unit 120 has an output malfunction, the malfunction processing unit 140 can prevent the main circuit unit 110 from transferring energy to the energy store and output unit 120 by sensing the abnormal rising of the output voltage of the energy store and output unit 120 and making the detected voltage of the valley detection unit 130 reflect the abnormal rising of the output voltage when an output voltage of the energy store and output unit 120 rises abnormally.

In an example, the malfunction processing unit 140 can be configured to prevent the main circuit unit 110 from being switched from the OFF status to the ON status and further prevent the main circuit unit 110 from transferring energy to the energy store and output unit 120 by adjusting the detected voltage of the valley detection unit 130 above the predetermined valley described above when an output voltage of the energy store and output unit 120 rises abnormally, in the case that the main circuit unit 110 stops transferring energy to the energy store and output unit 120.

As can be apparent from the foregoing description, the circuit device 100 as illustrated in FIG. 1 according to the embodiment of the present disclosure described above can prevent the main circuit unit 110 from transferring energy to the energy store and output unit 120 by adjusting the detected voltage of the valley detection unit 130 with the valley detection function of the valley detection unit 130 in the case that the energy store and output unit 120 has an output malfunction. In some embodiments, the voltage applied to the element in the energy store and output unit 120 can be avoided from being above the rated voltage thereof by the circuit device 100 according to the embodiment of the present disclosure, that is, the circuit device 100 can perform over-voltage protection of the element in the circuit.

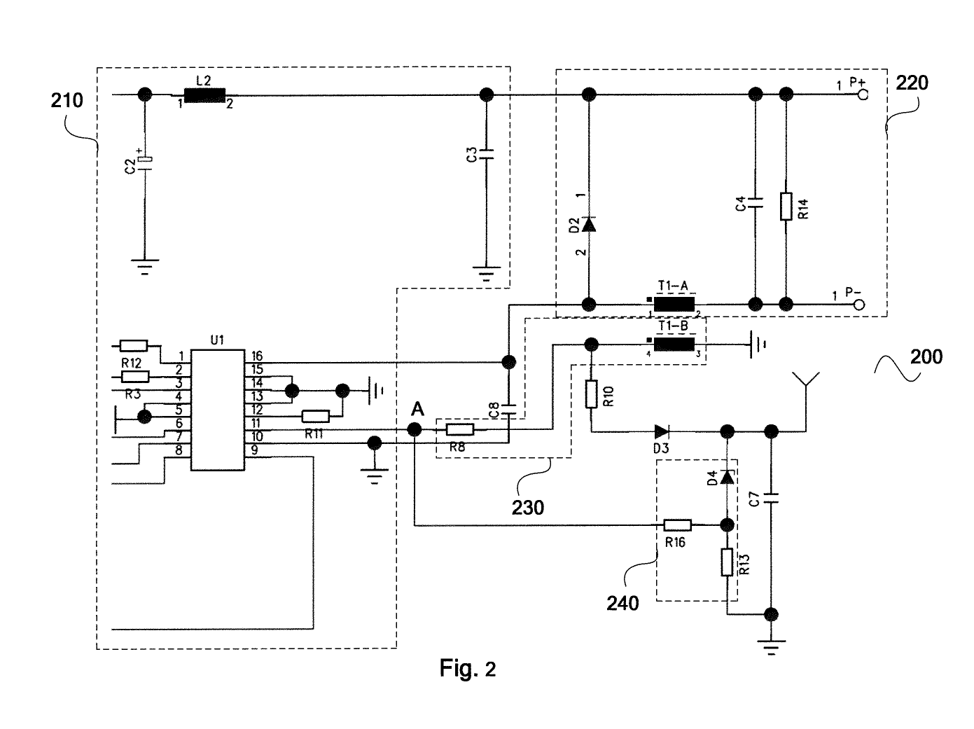

A specific application example of the circuit device according to the embodiment of the present disclosure will be described below with reference to FIG. 2. It shall be noted that the application example below is merely intended to illustrate and describe but not limit the embodiment of the present disclosure.

As illustrated in FIG. 2, the circuit device 200 includes an main circuit unit 210, an energy store and output unit 220, an valley detection unit 230 and an malfunction processing unit 240, which can have the same functions and processes as those of the main circuit unit 110, the energy store and output unit 120, the valley detection unit 130 and the malfunction processing unit 140 respectively as illustrated in FIG. 1, and the repeated description thereof will be omitted here. The malfunction processing unit 240 includes a zener diode D4, a first resistor R13 and a second resistor R16.

As illustrated in FIG. 2, a power supply capacitor C7 in the circuit device 200 is configured to supply power to a power management IC U1 (e.g., an IC SSL2101 chip), and a series circuit of the first resistor R13 and the zener diode D4 can be connected in parallel with the power supply capacitor C7. Particularly the cathode of the zener diode D4 is coupled with a high-potential end of the power supply capacitor C7. The anode of the zener diode D4 is coupled via the second resistor R16 with a coupling node A where the main circuit unit 210 is coupled with the valley detection unit 230 (as an example of the valley detection unit), where the control circuit 210 receives a detected voltage from the valley detection unit 230 at the coupling node A.

It shall be noted that FIG. 2 illustrates only a part of the circuit device 200. In a practical application, the circuit device 200 may also be configured with other circuit component parts, and FIG. 2 illustrates only apart directly relevant to the present disclosure. Furthermore it shall also be noted that the circuit device will not be limited to the implementation of the specific circuit type and configuration illustrated in FIG. 2 but also can be augmented or partially modified according to a practical condition.

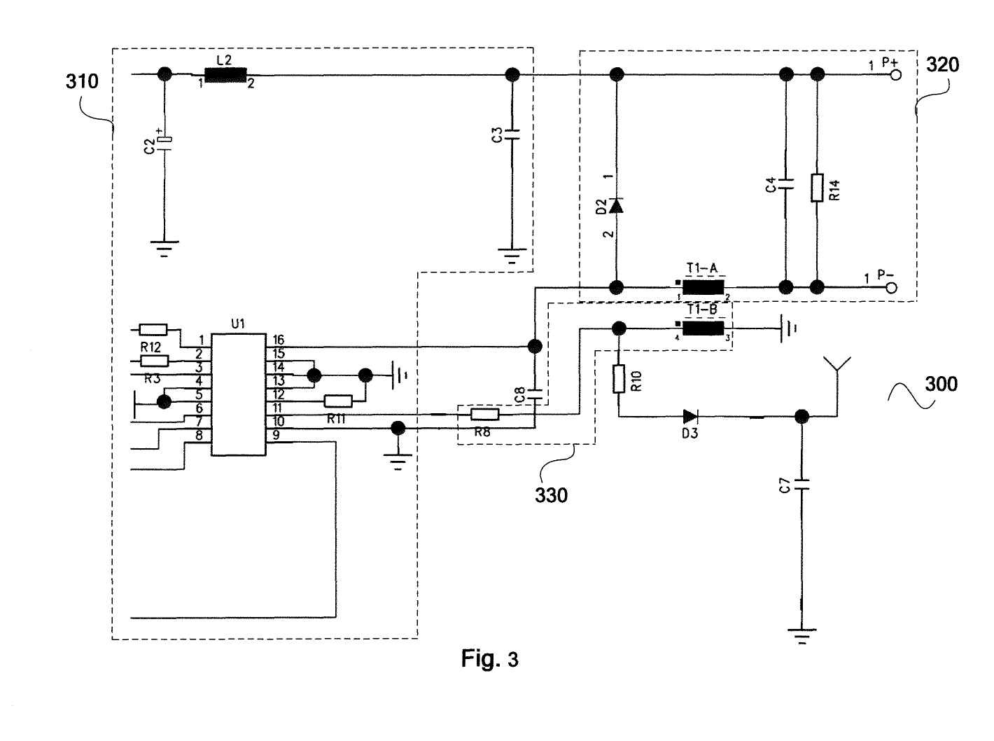

For the sake of a convenient understanding and description, FIG. 3 illustrates an example of a circuit scheme in the related art corresponding to FIG. 2. As illustrated in FIG. 3, the circuit 300 in the related art can include circuit component parts 310, 320 and 330 corresponding respectively to the circuit component parts 210, 220 and 230 in FIG. 2. Unlike FIG. 2, the circuit 300 in the related art in FIG. 3 does not include a circuit component part which can perform the function of the malfunction processing unit 240. It shall be noted that a description below of the circuit structure in FIG. 3 will be equally applicable to the elements in FIG. 2 with the same or similar reference numerals, and the description will not be repeated below.

As illustrated in FIG. 3, the main circuit unit 310 is implemented in a power management IC U1 (e.g., an IC SSL2101 chip) and auxiliary circuits thereof, where the pin 11 of the power management IC U1 is a valley detection pin of the power management IC U1 configured to receive the detected voltage of the valley detection unit 330. Furthermore the pin 16 of the power management IC U1 is a main switch pin configured to control the energy transfer to the energy store and output unit 320. In the ON status, the pin 16 of the power management IC U1 is coupled with the energy store and output unit 320 to enable the power management IC U1 to transfer energy to the energy store and output unit 320. In the OFF status, the pin 16 of the power management IC U1 is decoupled from the energy store and output unit 320 to enable the energy store and output unit 320 to release the stored energy thereof.

As illustrated in FIG. 3, the energy store and output unit 320 includes a buck inductor T1-A, a diode D2, an output capacitor C4 and a resistor R14, and 1P⁺ and 1P⁻ are outputs to be coupled with a load. The buck inductor T1-A is coupled with the pin 16 of the power management IC U1. The valley detection unit 330 includes an auxiliary winding T1-B and a resistor R8.

Typically the power management IC U1 can use the valley detection pin thereof (e.g., the pin 11 in FIG. 3) to detect whether power of the auxiliary winding T1-B is released. In the example illustrated in FIG. 3, the buck inductor T1-A and the auxiliary winding T1-B constitute a buck transformer, so the power of the auxiliary winding T1-B being released to some extent (for example, a voltage across the auxiliary winding T1-B below or at a predetermined voltage threshold) means that energy of the buck inductor T1-A is released to some extent and it is necessary for the power management IC U1 to resume the ON status to transfer energy to the buck inductor T1-A. Thus if it is detected whether the power of the auxiliary winding T1-B is released to some extent, then the main switch (not shown in FIG. 3) related to the pin 16 of the power management IC U1 will be enabled to start a new cycle; otherwise, it will be maintained in the OFF status.

In the circuit 300 in the related art, when the main switch related to the pin 16 of the power management IC U1 is in the ON status (corresponding to the ON status of the main circuit unit 310), the power management IC U1 transfers energy to the buck inductor T1-A, and energy is stored in the buck inductor T1-A in the form of magnetic energy. When the energy stored in the buck inductor T1-A accumulates to some extent, the main switch related to the pin 16 of the power management IC U1 is switched to the OFF status (corresponding to the OFF status of the main circuit unit 310), and the power management IC U1 stops transferring energy to the buck inductor T1-A, and the buck inductor T1-A starts releasing energy. If the outputs 1P⁺ and 1P⁻ are coupled normally with the load, then the buck inductor T1-A will power the load coupled between 1P⁺ and 1P⁻; and if the outputs 1P⁺ and 1P⁻ have a broken coupling(s) with the load, then the buck inductor T1-A will charge the output filter capacitor C4. Thus in the circuit 300 in the related art illustrated in FIG. 3, the voltage across the output filter capacitor C4 will rise. When the energy in the buck inductor T1-A is released to some extent, the pin 11 of the power management IC U1 will detect a voltage below or at a preset “valley”, so that the power management IC U1 will resume the ON status again to transfer energy to the buck inductor T1-A. Similarly when the main switch related to the pin 16 of the power management IC U1 is switched to the OFF status, the buck inductor T1-A starts charging the output filter capacitor C4, and the output filter capacitor C4 being charged may result in a further rising voltage thereof. This may be repeated so that the output filter capacitor C4 will be charged to a specific voltage above its own rated voltage and thus damaged and even possibly exploded. The foregoing situation may arise when a researcher or a developer adjusts the circuit in a lab, when a worker assembles a product or when a user using a lamp tube as a load performs a misoperation and consequently will fail an experiment, degrade the productivity or scare or hurt the user.

As compared with the circuit 300 in the related art illustrated in FIG. 3, the circuit device 200 illustrated in FIG. 2 can solve the problem described above.

As illustrated in FIG. 2, the circuit device 200 is also provided with the zener diode D4, the first resistor R13 and the second resistor R16 in addition to the power supply capacitor C7 and other elements existing in the circuit 300 in the related art so that the part enclosed by the dashed box “240” as illustrated in FIG. 2 can perform over-voltage protection of the output filter capacitor C4.

In the circuit device 200, after the main switch related to the pin 16 of the power management IC U1 is switched to the OFF status, the buck inductor T1-A starts releasing energy. If there is a broken coupling between the output circuit 220 and the load at this time, then the buck inductor T1-A starts charging the output filter capacitor C4 so that the voltage across the output filter capacitor C4 rises. In the loop consisted of the output filter capacitor C4, the diode D2 and the buck inductor T1-A, there is an almost constant voltage across the diode D2 despite the rising voltage across the output filter capacitor C4, so there is also an rising voltage across the buck inductor T1-A.

As illustrated in FIG. 2, the auxiliary winding T1-B is designed with a specific ratio of turns to the buck inductor T1-A. In the example illustrated in FIG. 2, there is a rated output of 30V (i.e., the rated voltage of the output filter capacitor C4) between 1P⁺ and 1P⁻. The number of turns of the buck inductor T1-A is 94 and the number of turns of the auxiliary winding T1-B is 48, and a voltage ratio between the buck inductor T1-A and the auxiliary winding T1-B is in proportion to the turns ratio between them. There is a reversed conduction voltage of 18V of the zener diode D4. The resistance of the resistor R13 is 100 kilohms and the resistance of the resistor R16 is 330 ohms, and the resistor R16 is configured to inhibit an excessive current flowing to the pin 11 of the power management IC U1.

Thus as the voltage across the buck inductor T1-A rises, the voltage across the auxiliary winding T1-B will also rise, so that there will also be an rising voltage across the power supply capacitor C7 supplying power to the power management IC U1 (the power supply capacitor C7 is coupled with the pin 3 of the power management IC U1, which is not illustrated). When the power supply capacitor C7 is charged above 18V which equals to the reversed conduction voltage of the zener diode D4, the reverse breakdown of the zener diode D4 occurs, and a current flows from the high-potential end of the power supply capacitor C7 to the ground through the zener diode D4 and the first resistor R13, thus resulting in a voltage drop across the first resistor R13.

When the current on the buck inductor T1-A drops to zero, the auxiliary winding T1-B stops charging the power supply capacitor C7, but the voltage drop of the power supply capacitor C7 is maintained above 18V for a period of time. Also the voltage across the first resistor R13 (which is connected with the pin 11 of the power management IC U1 through the second resistor R16) will be maintained above 0.1V (as an example of the predetermined valley). Thus in the case the pin 11 of the power management IC U1 detects a voltage above 0.1V, the main switch related to the pin 16 of the power management IC U1 will be maintained in the OFF status for a long period of time.

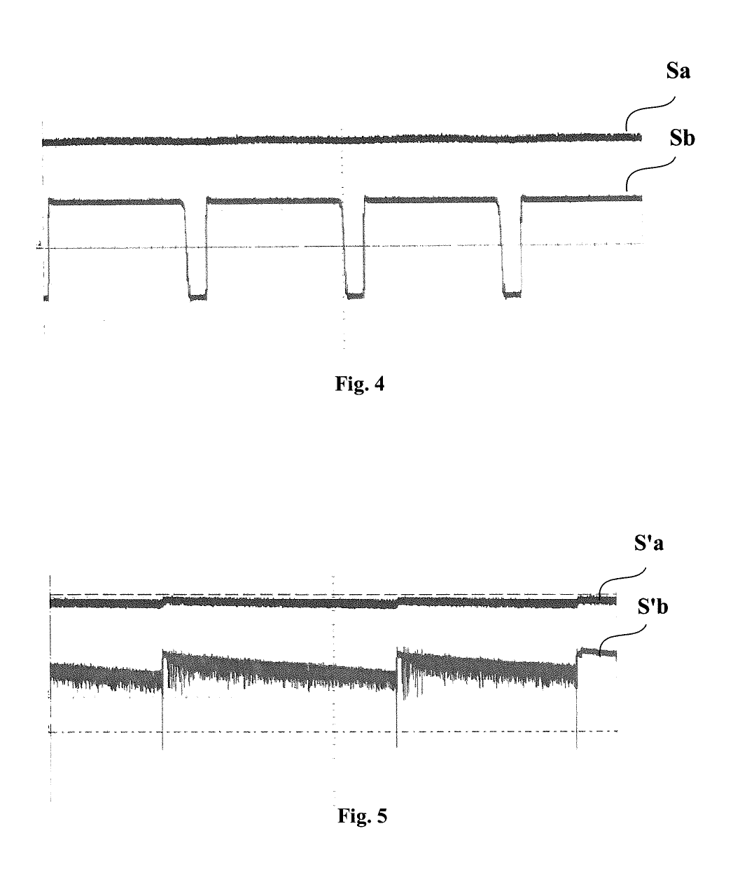

As illustrated in FIG. 4, the output voltage of the circuit device 200 has a waveform as represented by Sa and the voltage detected by the pin 11 of the power management IC U1 has a waveform as represented by Sb in normal operation (that is, in the case that the output part is coupled with the load). Observation of the waveforms described above shows sags occurring in the waveform Sb at a fixed interval of time, and each of the sages is equivalent to the “valley” described above.

As illustrated in FIG. 5, the output voltage of the circuit device 200 has a waveform as represented by S′a and the voltage detected by the pin 11 of the power management IC U1 has a waveform as represented by S′b in the abnormal situation (that is, in the case that the output part has a broken coupling with the load). Unlike the waveform Sb, observation of the waveforms described above shows no sag occurring in the waveform S′b, that is, the circuit device 200 described above can have no valley detected by the pin 11 of the power management IC U1 for a long period of time.

In addition, when the voltage cross the power supply capacitor C7 drops below 18V, zener diode D4 is cut off, no current will flow through the first resistor R13, and at this time the pin 11 of the power management IC U1 detects a voltage below 0.1V. Also the output voltage of the output filter capacitor C4 is discharged by the resistor R14 to a low value, and the main switch related to the pin 16 of the power management IC U1 will be enabled again, such that the power management IC U1 transfers energy to the buck inductor T1-A again. When the energy stored in buck inductor T1-A accumulates to some extent, buck inductor T1-A starts charging the output filter capacitor C4, the voltage across the output filter capacitor C4 will rise from the low value again, so that the output voltage (i.e., the voltage across the output filter capacitor C4) rises to a high voltage and discharged by R14 repeatedly and cyclically to thereby maintain the output voltage at or below the preset value. Thus the peak of the output voltage can be set simply by changing the reversed conduction voltage of the zener diode D4. In FIG. 2, there is an output peak voltage of 41V and a power input of approximately 0.47 W (in the case that the malfunction processing unit 240 is operative). With this function, the circuit device 200 can resume its operation automatically when the load is reconnected. It shall be noted that the case in which the voltage cross the power supply capacitor C7 drops below 18V is not illustrated in FIG. 5 for the sake of clarity and conciseness.

In the application example described above, the malfunction processing unit 240 can be implemented with only a few elements to protect effectively a circuit element at a low cost. Although the malfunction processing unit 240 is composed of the zener diode D4, the first resistor R13 and the second resistor R16 in the example as shown in FIG. 2, the circuit arrangement for implementing the malfunction processing unit 240 is not limited thereto. Those skilled in the art can easily conceive of any other suitable circuit arrangements to construct such malfunction processing unit based on the present disclosure, which circuit arrangements being capable of sensing the abnormal rising of the output voltage of the energy store and output unit and making the abnormal rising of the output voltage be reflected in the detected voltage of the valley detection unit.

It shall be noted that the respective elements given in the application examples described above are merely exemplary and other elements can also be included in other embodiments of the present disclosure according to specific application scenarios.

Furthermore, in a specific implementation of the circuit device according to the embodiment of the present disclosure, the circuit device can be applicable to any one of the various topologies of a reverse buck topology, a low-side buck topology, a fly-back topology and a boost-buck topology, not being limited to the topology illustrated in FIG. 5.

In addition, the parameters of the respective elements described above will not be limited to the values given above, and other values can be derived by those skilled in the art in combination with their general knowledge and should also be within the scope of protection of the present application.

It shall be noted that the function units of the circuit device according to the respective embodiments of the present disclosure described above can be combined as appropriate for the purpose of the disclosure. For the sake of conciseness, specific details of circuit devices formed in the respective combinations will not be enumerated here.

Furthermore an embodiment of the present disclosure also provides an electronic apparatus including the circuit device as described above, and the circuit device is used to drive a load of the electronic apparatus, such as one or more LEDs. Thus the electronic apparatus can have all the advantageous effects of the circuit device described above, and a repeated description thereof will be omitted here.

Particularly in a specific implementation of the electronic apparatus according to the embodiment of the present disclosure, the electronic apparatus can be a constant-current power supply such as an LED driver.

In the above description of the embodiments of the present disclosure, the features described and/or illustrated with respect to one implementation may be used, in the same or similar manner, in one or more other embodiments, in combination with the features in other embodiments, or to substitute for the features in other embodiments.

Although there has disclosed above the present invention by way of the descriptions of the specific embodiments of the invention, it should be understand that various modifications, improvements and equivalents of the present invention can be devised by those skilled in the art without departing from the spirit and scope as defined in the appended claims. These modifications, improvements and equivalents should also be within the scope of protection of the present invention.

Finally it should be noted that, in the present disclosure, relational terms such as “left” and “right”, “first” and “second” are used only to distinguish one entity or operation from another entity or operation, but not necessarily demand or imply that there is actual relation or order among those entities and operations. Furthermore, the terms “include”, “including”, “comprise”, “comprising”, or any other variations thereof means a non-exclusive inclusion, so that the process, article or apparatus that includes a series of elements includes not only these elements but also other elements that are not explicitly listed, or further includes elements inherent in the process, article or apparatus. Moreover, when there is no further limitation, the element defined by the wording “include (s) a . . . ” or “comprise (s) a . . . ” does not exclude the case that there are other same elements in the process, article or apparatus that includes the element.

1. A circuit device, comprising:
a main circuit unit,
an energy store and output unit,
a valley detection unit for detecting the voltage at the output unit and providing a detection voltage for the main circuit unit, the main circuit unit transferring energy to the energy store and output unit according to the detection voltage representing the voltage at the output unit detected by the valley detection unit, and
a malfunction processing unit configured to prevent the main circuit unit from transferring energy to the energy store and output unit by adding an additional voltage to the detection voltage of the valley detection unit in the case that the energy store and output unit has an open-circuit malfunction.

2. The circuit device according to claim 1, wherein the malfunction processing unit is configured to:
judge that the energy store and output unit has an output malfunction when an output voltage of the energy store and output unit rises abnormally, in the case that the main circuit unit stops transferring energy to the energy store and output unit.

3. The circuit device according to claim 2, wherein the malfunction processing unit is configured to:
prevent the main circuit unit from transferring energy to the energy store and output unit by sensing the abnormal rising of the output voltage of the energy store and output unit and making the detected voltage of the valley detection unit reflect the abnormal rising of the output voltage when the malfunction processing unit judges that the energy store and output unit has an output malfunction.

4. The circuit device according to claim 1, wherein the circuit device comprises any one of the following topologies:
a reverse buck topology, a low-side buck topology, a fly-back topology and a boost-buck topology.

5. The circuit device according to claim 1, wherein
the malfunction processing unit comprises a zener diode, a first resistor and a second resistor, a series circuit of the first resistor and the zener diode is connected in parallel with a power supply capacitor for supplying power to the main circuit unit, the cathode of the zener diode is coupled with a high-potential end of the power supply capacitor, and the anode of the zener diode is coupled through the second resistor with a coupling node at which the main circuit unit is coupled with the valley detection unit, wherein the main circuit unit receives the detected voltage of the valley detection unit at the coupling node.

6. An electronic apparatus, comprising a circuit device for driving a load of the electronic apparatus, the circuit device comprising:
a main circuit unit,
an energy store and output unit,
a valley detection unit for detecting the voltage at the output unit and providing a detection voltage for the main circuit unit, the main circuit unit transferring energy to the energy store and output unit according to the detection voltage representing the voltage at the output unit detected by the valley detection unit, and
a malfunction processing unit configured to prevent the main circuit unit—from transferring energy to the energy store and output unit by adding an additional voltage to the detection voltage of the valley detection unit in the case that the energy store and output unit has an open-circuit malfunction.

7. The electronic apparatus according to claim 6, wherein the electronic apparatus is a constant-current output power supply.

8. The electronic apparatus according to claim 7, wherein the electronic apparatus is an LED driver.
